(19) United States
(12) Patent Application Publication
(10) Pub. No.: US 2022/0208219 A1
(43) Pub. Date: Jun. 30, 2022

(54) Capacitor Discharge Magnet Degausser Mechanism for Destroying the Functionality of Data Bearing Components of Magnetic Media Data Bearing Devices

(71) Applicant: Sepehr Rajaie, Reynoldsburg, OH (US)

(72) Inventor: Sepehr Rajaie, Reynoldsburg, OH (US)

(21) Appl. No.: 17/139,978

(22) Filed: Dec. 31, 2020

(51) Int. Cl. G11B 5/024; H01F 13/00

(52) U.S. Cl. CPC G11B 5/0245; H01F 13/006

(57) ABSTRACT

The current invention is a Capacitor Discharge Magnet Degausser Mechanism for Destroying the Functionality of Data Bearing Components of Magnetic Media Data Bearing Devices. It provides reconciliation and tracking with a unique identification tag using a secure and proprietary database, destruction of the functionality of the data bearing components of magnetic media data bearing devices using an automated movement system, a NSA Certified high strength Capacitor Discharge Magnet degausser, digital pre-degaussing and post-degaussing readings to indicate the completion of the process of destroying the functionality of the data bearing components including storage of readings and containment of the remains of the magnetic media devices for verification.

### CROSS-REFERENCES TO RELATED APPLICATIONS (IF ANY)

None

### BACKGROUND

### 1. Field of the Invention

The present invention relates to a device for destroying the functionality of data bearing components of magnetic media data bearing devices.

### 2. Description of Prior Art

Magnetic media data bearing devices that eventually fail or are decommissioned are separated from the host server or array or other computer device and need to have the functionality of the data bearing components destroyed so that the data is no longer usable. This process must be verified to meet cyber security regulations.

Other systems may not track devices during the data destruction process. Other systems may not have methods for reading completion of their process or digital storage of readings to show that the functionality of data bearing components has been destroyed. Other systems may not be intended for use with magnetic media data bearing devices that have had changes in their characteristics. Other systems may not be changeable to meet changes made to cyber security regulations. Other systems may not process magnetic media data bearing devices in a time saving manner. Other systems may not be used within an organization's secure location.

There is still room for improvement in the art.

### SUMMARY OF THE INVENTION

The present invention is a Capacitor Discharge Magnet degausser mechanism that provides reconciliation and tracking with a unique identification tag using a secure and proprietary database, destruction of the functionality of the data bearing components of magnetic media data bearing devices using an automated movement system, a NSA Certified high strength Capacitor Discharge Magnet degausser, digital pre-degaussing and post-degaussing readings to indicate the completion of the process of destroying the functionality of the data bearing components including storage of readings for verification, and containment of the remains of the magnetic media devices for verification.

This Capacitor Discharge Magnet degausser mechanism is portable and is intended to be used within the customer's secure confines of a data center or enterprise facility. This Capacitor Discharge Magnet degausser is anticipated to be able to process 10,000 units in 8 hours. This Capacitor Discharge Magnet degausser mechanism has components that are modular and can be changed based on changes in the characteristics of magnetic media data bearing devices and changes in the cyber security regulations for data destruction.

It is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a diagram of some of the components of the invention; and

FIG. 2 shows a flowchart of the invention.

### DESCRIPTION OF THE PREFERRED EMBODIMENT

There are a number of significant design features and improvements incorporated within the invention.

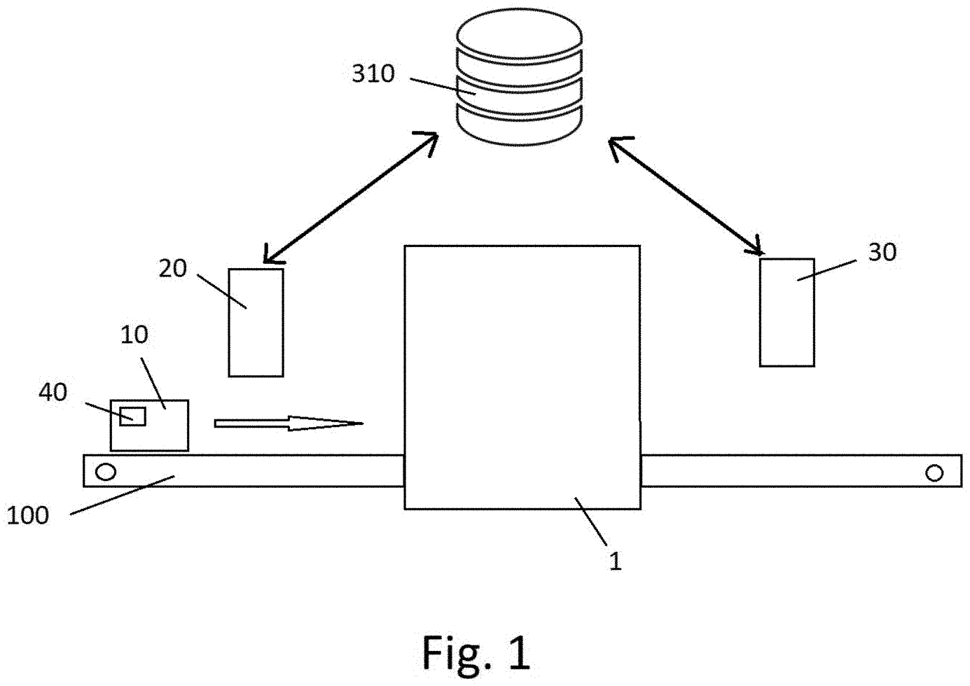

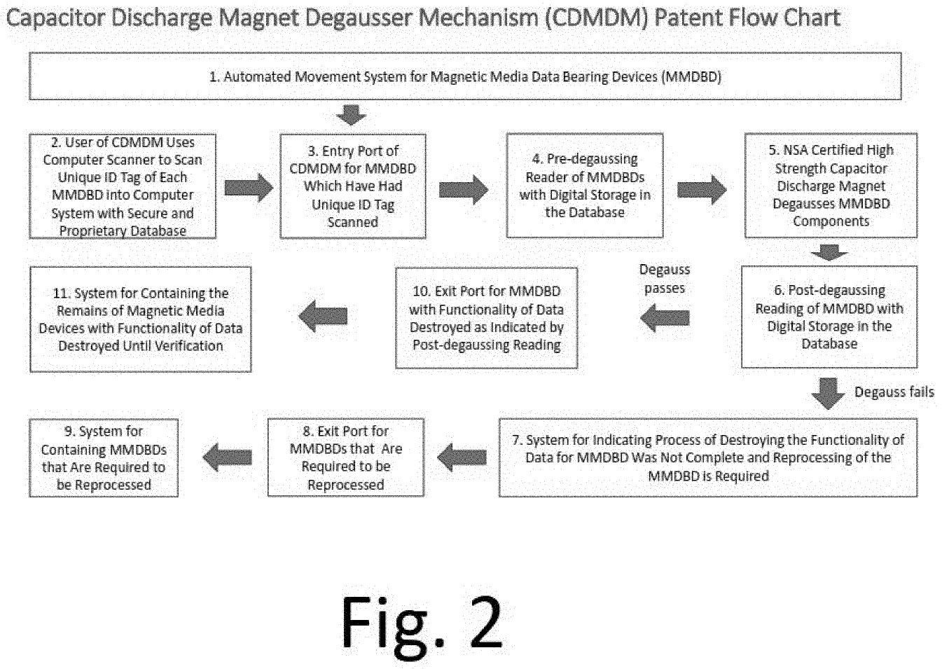

As shown in FIGS. 1 and 2, the present invention is a Capacitor Discharge Magnet degausser mechanism 1 that provides reconciliation and tracking with a unique identification tag 40 using a secure and proprietary database, processing to destroy the functionality of the data bearing components of magnetic media data bearing devices 10 using an automated movement system 100, a NSA Certified high strength Capacitor Discharge Magnet degausser, digitally stored pre-degaussing and post-degaussing readings to indicate that the functionality of the data bearing components has been destroyed, and containment of the remains of magnetic media devices 10 for verification. Also, the Capacitor Discharge Magnet degausser mechanism 1 can be produced to allow for transportation to and use of the mechanism 1 within the customer's secure locations. The components of this Capacitor Discharge Magnet degausser mechanism 1 are modular and can be changed based on changes in the characteristics of magnetic media products and changes in the cyber security regulations for data destruction.

Magnetic media data bearing devices 10 that eventually fail or are decommissioned are separated from the host server or array or other computer device and need to have the functionality of the data bearing components destroyed so that the data is no longer usable. This process must be verified to meet cyber security regulations. The current invention claimed here solves this problem.

When the failed or decommissioned magnetic media data bearing device 10 is removed from the host server or array or other computer and is designated for destruction of data, it will be reconciled and tracked by being enrolled into the secure and proprietary database 310 and assigned a unique identification tag 40. It will be processed using the Capacitor Discharge Magnet degausser mechanism 1 to destroy the functionality of the data bearing components using an automated movement system 100 and an NSA Certified high strength Capacitor Discharge Magnet degausser. Digital pre-degaussing and post-degaussing readings will be part of the mechanism 1 to indicate that the functionality of the data bearing components has been destroyed and are recorded for later verification. If the post-degaussing reading indicates that the functionality of the data bearing components has not been destroyed, an indicator will be activated, and that magnetic media data bearing device 10 will be contained in a designated container in order to repeat the Capacitor Discharge Magnet degausser mechanism 1 processing to achieve a post-degaussing reading that indicates the functionality of the data bearing components has been destroyed. Magnetic media devices 10 that have post-degaussing readings that indicate the functionality of the data bearing components has been destroyed will be contained in a designated container for verification.

The Capacitor Discharge Magnet degausser mechanism 1 is able to process a large volume of pieces per hours. Also, this Capacitor Discharge Magnet degausser mechanism 1 can be produced to allow for transportation to and use of the mechanism 1 within the customer's secure locations. The components of this Capacitor Discharge Magnet degausser mechanism 1 are modular and can be changed based on changes in the characteristics of magnetic media products and changes in the cyber security regulations for data destruction.

Other systems do not track devices 10 during the data destruction process. Other systems do not have methods for reading completion of their process to show that the functionality of the magnetic media data bearing components has been destroyed. Other systems do not have digital storage of pre-processing and post-processing readings for verification. Other systems do not destroy the functionality of data bearing components on magnetic media data bearing devices 10. Other systems process data bearing devices 10 in a location that is outside the secure confines of a data center or enterprise facility which constitutes a security risk. Other systems do not destroy data in a time saving manner. Other systems are not changeable for use with magnetic media data bearing devices 10 that have had changes in their characteristics. Other systems are not changeable to meet changes made to cyber security regulations.

### Process

As shown in FIG. 2, if the magnetic media data bearing device 10 that presently or at one time held data is at the end of life, then the organization will want to decommission it and safely and securely destroy the functionality of the data on the magnetic media data bearing device. If the magnetic media data bearing device 10 has been determined as ready for decommissioning and is removed from the host server or array or other computer device, then it will be reconciled and tracked with a unique identification tag 40 using a secure and proprietary database 310. If the magnetic media data bearing device 10 is reconciled and tracked with a unique identification tag 40 using a secure and proprietary database 310, then it will be designated for destruction. If the magnetic media data bearing device 10 is designated for destruction, then the user of the Capacitor Discharge Magnet degausser mechanism 1 will use the automated system for movement 100 to insert the magnetic media data bearing device 10 into the Capacitor Discharge Magnet degausser mechanism 1.

The following Steps 1-6 are completed in order as listed.

Step 1 begins the process of moving the magnetic media data bearing device 10 into the Capacitor Discharge Magnet degausser mechanism 1. Step 2 is when the magnetic media data bearing device 10 has its unique identification tag 40 scanned into the database 310. Step 3 is when the magnetic media data bearing device 10 enters the Capacitor Discharge Magnet degausser mechanism 1. Step 4 is the reading and recording of the magnetic media data bearing device 10 by the pre-degaussing reader 20. Step 5 is the destroying of the functionality of the data on the magnetic media data bearing device 10 within the Capacitor Discharge Magnet degausser mechanism 1. Step 6 is the reading and recording of the magnetic media device 10 by the post-degaussing reader 30. Step 7 is the system which is activated when the post-degaussing reading indicates that the functionality of the data bearing components of the magnetic media data bearing device 10 was not complete and includes auditory and/or visual signals to the operator of the Capacitor Discharge Magnet degausser mechanism 1. Step 8 is the exit of the magnetic media data bearing device 10 that does not have the functionality of the data bearing components destroyed and that requires reprocessing through a designated exit port leading to Step 9, which is the system for containing magnetic media data bearing devices 10 to be reprocessed starting at Step 1. Step 10 is the exit of the magnetic media that has the functionality of the data destroyed as indicated by the (Step 5) post-degaussing reader 30 through a designated exit port leading to Step 11 which is the system for containing the remains of magnetic media with functionality of data destroyed until verification.

### Advantages

Additionally: Any organization that wants to destroy the functionality of magnetically stored information would want to use this Capacitor Discharge Magnet degausser mechanism as described to ascertain that the functionality of the stored information no longer exists. Therefore, the process would protect the organization from information security compromise, which would save them from spending time and resources to counteract the loss.

The current invention is a new method to destroy the functionality of data on magnetic media data bearing devices 10, a new method of pre-degaussing and post-degaussing readings to indicate completion of the process of destroying the functionality of magnetically stored data or information and a new method for automated movement and designated exit and containment of devices or return for reprocessing based on post-degaussing readings.

### CONCLUSION

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A device of destroying data:
a capacitor discharge magnet degausser mechanism having a pre-degaussing reader and a a post-degaussing reader, where the magnetic media data bearing device has an identification tag and having a secure database, and having an exit port.

2. A device according to claim 1 further comprising:
having an automated system for movement.

3. A device according to claim 1 further comprising:
where the data is on a magnetic media data bearing device.

4. (canceled)

5. (canceled)

6. (canceled)

7. A device according to claim 1 further comprising:
having an exit port.

8. (canceled)

9. (canceled)

10. A process to destroy data comprising;
having a data storage device;
having a capacitor discharge magnet degausser mechanism;
moving the data storage device through the capacitor discharge magnet degausser mechanism;
tagging the device with an ID tag which is scanned into a secured database;
having a pre-degaussing reader;
having a post-degaussing reader;
scanning the data storage device after it has gone through the capacitor discharge magnet degausser mechanism and resending through the capacitor discharge magnet degausser mechanism if there still data on the data storage device;
having an exit port; and
exiting the data storage device if the data on the data storage device has been removed.

11. (canceled)

12. The process according to claim 10 further comprising:
having an automated system for movement.

13. (canceled)

14. (canceled)

15. (canceled)

16. The device according to claim 1 where the components are modular.

17. The device according to claim 10 where the components are modular.
